(19) United States
(12) Patent Application Publication
(10) Pub. No.: US 2005/0185852 A1
(43) Pub. Date: Aug. 25, 2005

(54) Method and apparatus to generate complex borders

(76) Inventors: Jiliang Song, Richmond (CA); Barinder Singh Rai, Surrey (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/783,278

(22) Filed: Feb. 20, 2004

(51) Int. Cl. G06K 9/36; G06K 9/46

(52) U.S. Cl. 382/243; 382/284

(57) ABSTRACT

A method for incorporating a border around a displayed image is provided. The method initiates with identifying a main image. The method includes selecting a border image to be associated with the main image. Then, the border image is mapped to a table such that each pixel of the border image is represented by a corresponding single bit in the table. The mapping to the table includes defining a first single bit value for respective border image pixels and defining a second single bit value for respective main image pixels. The method includes applying the table to a display of the main image in order to incorporate the border image with the main image. A graphics processing device and a device configured to generate a border for a displayed image are included.

### BACKGROUND OF THE INVENTION

1. Field of the Invention

This invention relates generally to computer systems and more particularly to a method and apparatus for generating a border for a displayed image.

2. Description of the Related Art

Liquid crystal display (LCD) controller designs typically use an overlay technique for applying a border to a main image. In this technique the overlay is placed on top of the main image and the transparent bits (where the image data is shown) are specified. The memory requirements are relatively large for this technique as both the overlay image and the main image are stored in memory. One skilled in the art will appreciate that where the color depth for the overlay and/or main image is 8 bpp or more, the memory requirements increase drastically. Of course, the power consumption increases along with the memory requirements.

The increased memory and higher power consumption rate become a problem for certain battery operated consumer electronic devices. For example, with respect to cell phones, it is becoming commonplace to capture an image through a camera of the cell phone, place a border around the image and transmit the image to another user. However, the traditional border generation scheme using an overlay consumes an excessive amount of memory and power for the cell phone applications. Techniques to address these shortcomings sacrifice border design choices and limit the user's ability to customize the border in order to reduce the memory requirements and power consumption.

As a result, there is a need to solve the problems of the prior art to provide a border generation scheme that reduces memory requirements and power consumption without limiting the border options available to a user.

### SUMMARY OF THE INVENTION

Broadly speaking, the present invention fills these needs by providing a method and apparatus for border generation for an image through a relatively simple compression scheme that reduces memory requirements. It should be appreciated that the present invention can be implemented in numerous ways, including as a process, a system, or a device. Several inventive embodiments of the present invention are described below.

In one embodiment, a method for incorporating a border around a displayed image is provided. The method initiates with identifying a main image. The method includes selecting a border image to be associated with the main image. Then, the border image is mapped to a table such that each pixel of the border image is represented by a corresponding single bit in the table. The mapping to the table includes defining a first single bit value for respective border image pixels and defining a second single bit value for respective main image pixels. The method includes applying the table to a display of the main image in order to incorporate the border image with the main image.

In another embodiment, a method for customizing a border around a displayed image is provided. The method initiates with identifying a main image. The method includes selecting a border image to be associated with the main image. Then, a table representing a template for the border image and the main image is defined such that each pixel of the border image is represented by a corresponding first single bit in the table and the main image is represented by a corresponding second single bit in the table.

In yet another embodiment, a graphics processing unit (GPU) is provided. The GPU includes border generation logic configured to apply a border to an image. The border generation logic includes logic for generating a table mapping border data with image data such that both the border data and the image data are represented by corresponding single bit values in the table. The border generation logic also includes logic for compressing the border data and the image data such that multiple successive single bit values in the table are compressed to a value. The value represents whether one of the corresponding single bit values is one of a first single bit value and a second single bit value, and a number of identical single bit values following the one of the corresponding single bit values in the table. Logic for storing the compressed data in a buffer associated with the GPU is included.

In another embodiment, a device is provided. The device includes a graphics processing unit (GPU) configured to provide image data having a border to a display panel for presentation. The GPU includes logic for generating a table mapping border data with the image data. The table is defined by single bit values. The GPU includes logic for compressing the single bit values of the table such that repeated successive single bits in the table are compressed to an eight bit value having a most significant bit determining whether the repeated successive single bits are associated with one of the border data and the image data, wherein a remaining seven bits of the eight bit value represent a quantity of the repeated single bits.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified schematic diagram illustrating a border to be applied to an image in accordance with one embodiment of the invention.

FIG. 2 is a simplified schematic diagram of a main image around which a border will be placed in accordance with one embodiment of the invention.

FIG. 3 is a simplified schematic diagram illustrating a mapped table used for incorporating a main image with a border image in accordance with one embodiment of the invention.

FIG. 4 is a simplified schematic diagram illustrating a display presented when the main image of FIG. 2 and the border image of FIG. 1 are combined through the table of FIG. 3 in accordance with one embodiment of the invention.

FIG. 5 is a simplified schematic diagram illustrating the data structure representing the mapped table in accordance with one embodiment of the invention.

FIG. 6 is a schematic diagram of a mapped table and corresponding compressed data for use in illustrating the methodology to generate complex borders in a graphics controller in accordance with one embodiment of the invention.

FIG. 7 is a high level schematic diagram illustrating a device configured to provide borders in an efficient manner in accordance with one embodiment of the invention.

FIG. 8A is a schematic diagram further defining the border generation logic of FIG. 7.

FIG. 8B is an alternative embodiment to the border generation logic illustrated in FIG. 8A.

FIG. 9 is a flowchart diagram illustrating the method operations incorporating a border with a main image in accordance with one embodiment of the invention.

### DETAILED DESCRIPTION OF THE PREFERRED EMBODIMENTS

An invention is described for an apparatus and method for generating a border for an image while minimizing memory requirements for the electronic device displaying the image with the border. The minimization of memory requirements enhances battery life by reducing power consumption. It will be obvious, however, to one skilled in the art, that the present invention may be practiced without some or all of these specific details. In other instances, well known process operations have not been described in detail in order not to unnecessarily obscure the present invention.

The embodiments of the present invention provide a method and device that uses a relatively small display buffer to generate a border to be incorporated with an image. The border may be a custom border designed and input by the user. In the alternative, the border may be downloaded from a distributed network, e.g., the Internet. In one embodiment, a table provides a mapping between the border image and the main image. The table is populated by single bit values which are associated with either the border image or the main image. Thus, the single bit values determine whether a corresponding pixel of a displayed image is associated with the border image or the main image. One skilled in the art will appreciate that a significant savings in terms of memory is realized here relative to an overlay method where the image data and the overlay data may be defined by a color depth of 8 bits per pixel (bpp) or more.

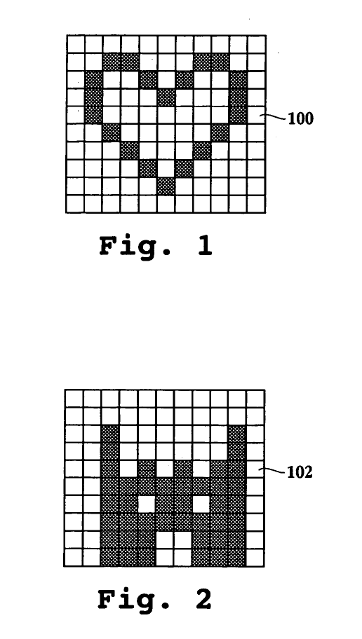

In another embodiment, the mapped table is compressed through the application of a compressed data structure to further reduce the memory requirements. Here, the mapped table is saved as a series of bytes, where each byte represents a portion of the mapped table. The byte is composed of a most significant bit (MSB) representing the pattern, i.e., whether the data corresponds to the border image or the main image, and the remaining seven bits. The remaining seven bits of the byte represents the number of consecutive bits associated with the particular pattern represented by the MSB as discussed in more detail below. FIGS. 1-6 are provided as a framework to discuss an exemplary illustration of the scheme for generating any border for use with an image through a graphics controller also referred to as a graphics processing unit (GPU). As these Figures are exemplary, it should be appreciated that the invention is not limited to the border and image types discussed in the Figures. That is, the embodiments discussed below may be applied to any suitable border shape, border color, etc., and any suitable main image.

FIG. 1 is a simplified schematic diagram illustrating a border to be applied to an image in accordance with one embodiment of the invention. Border region 100 defines a heart shaped border. As mentioned above, border region 100 may be any shape suitable for a border. It should be appreciated that the grids in FIG. 1 are illustrated for ease of reference.

FIG. 2 is a simplified schematic diagram of a main image around which a border will be placed in accordance with one embodiment of the invention. Image 102 represents a castle and will be placed inside border region 100 of FIG. 1 as described below. Here again, the grids of FIG. 2 are used for reference purposes.

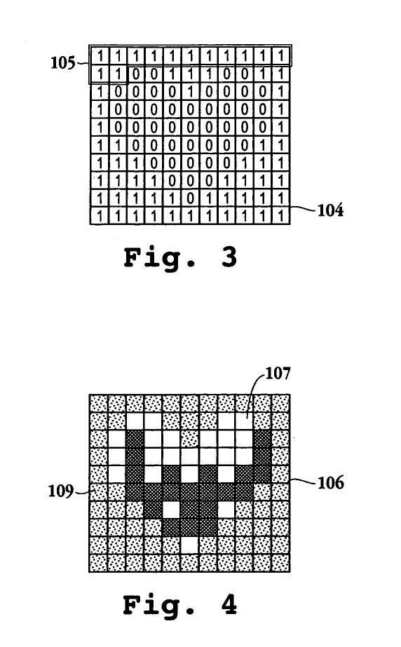

FIG. 3 is a simplified schematic diagram illustrating a mapped table used for incorporating a main image with a border image in accordance with one embodiment of the invention. Mapped table 104 includes logical high values “1” and logical low values “0”. As can be seen, the logical high values represent a border color, while the logical low values represent the main image. Of course, the logical high values may represent the main image color and the logical low values may represent the border color. That is, it is only necessary that two different values are used to represent the corresponding main image color and border color. One skilled in the art will appreciate that while the grids of FIGS. 1-3 are provided for reference purposes, the grids may be thought of as pixels. Furthermore, as each of the values of table 104 are single bit values, a significant memory saving is achieved as compared to a table having values associated with a color depth of 8 bpp or more.

FIG. 4 is a simplified schematic diagram illustrating a display presented when the main image of FIG. 2 and the border image of FIG. 1 are combined through the table of FIG. 3 in accordance with one embodiment of the invention. Here, image 102 of FIG. 2 is incorporated into border region 100 of FIG. 1 resulting in image 106 being presented on a display screen. That is, image 106 includes heart shaped region 107 in which the main image, i.e., pixels associated with the main image are displayed, and border region 109 which is outside of heart shaped region 107, where the border color is displayed. While mapped table 104 of FIG. 3 conserves memory in that each pixel associated with the combination of the border image and the main image of FIGS. 1 and 2, respectively, are represented by a single bit value. That is, the logical high value and logical low value are single bit values as opposed to having a color depth of eight bits per pixel, sixteen bits per pixel, etc. However, storing the data in the mapped table as single bit values requires a relatively large amount of memory for a large panel. For example, for a 132×176 panel, the mapped table needs (132×176)/8 which is equal to 2,904 bytes of memory. In order to further save or conserve memory or display buffer resources, a special data structure is used to compress the data of the mapped table. Rather than storing the raw data in the display buffer, i.e., each single bit value, the data is compressed as described below.

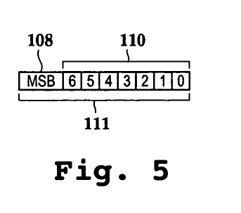

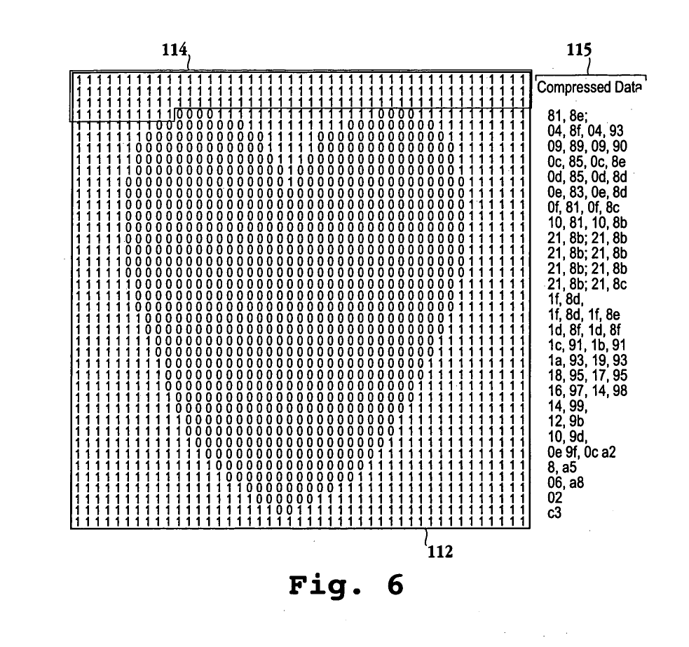

FIG. 5 is a simplified schematic diagram illustrating the data structure representing the mapped table in accordance with one embodiment of the invention. Data structure 111 is stored into a frame buffer and requires less memory than storage of each of the single bit values of the mapped data table due to the repetitive nature of the single bit values. Data structure 111 consists of a byte of data, i.e., 8 bits of data. Most significant bit (MSB) 108 represents the pattern, e.g., the border or the main image. That is, most significant bit 108 may either be a zero or a one, with reference to the mapped table of FIG. 3. Thus, the two different bit values represented in the mapped table are used as the most significant bit in the data structure, thereby representing a source of the data as either the main image or the border image. For example, where the mapped table indicates a border color, the MSB associated with the border color will be a “1.” Alternatively, if the mapped table indicates a main image color or pixel, the MSB will be a “0.” The remaining seven bits 110 of byte 111 are used to indicate how many times the pattern is repeated. Thus, MSB 108 establishes a pattern or a bit value to be used, while remaining seven bits 110 determine how many times that pattern or bit value is replicated.

For example, referring back to FIG. 3, starting at the upper left hand corner of mapped table 104 and counting across each row from left to right, it should be appreciated that there are thirteen “1's” at the beginning of the mapped table before a “0” is encountered. The thirteen “1's” are illustrated in region 105 of FIG. 3. One skilled in the art will appreciate that if all thirteen “1's” are stored in the raw data format, then thirteen bits of memory are required. However, only one byte (8 bits) is required to store the information in the compressed mode as described herein.

Continuing with the example discussed above with reference to FIG. 3, the byte value is 10001101_{b} (binary) or 8Dₕ (hexadecimal) where the lower 7 bits of the byte represent the decimal number of 13 and the MSB means the pattern is “1”, i.e., the border. The lower 7 bits of the byte (0001101) signify “1” is replicated 13 times. As 7 bits only can represent a maximum value of 128, it is necessary to provide a technique to capture strings of a value where the value is replicated more than 128 times. In order to represent numbers larger than 128, two or more consecutive bytes with the same MSB are used to represent the larger numbers. The following example illustrates this technique:

In a mapped table there are 57h “0's”, following 1345h “1's”, then following 12h “0's”. Here, 4 bytes used to store the information: 57h, A6h, C5h, 12h. That is, 1345h in binary form is 0001 0011 0100 0101b. As this number is greater than the 128 maximum for a seven bit number, two bytes are used to capture the string of “1's”. It is necessary to insert 2 MSB's (having a value of “1”). The resulting number is as follows:
1010 0110 1100 0101_{b}
   (which correlates to A6ₕ and C5ₕ in hexadecimal). The underlined “1” values in the resulting number represent the inserted MSB's.

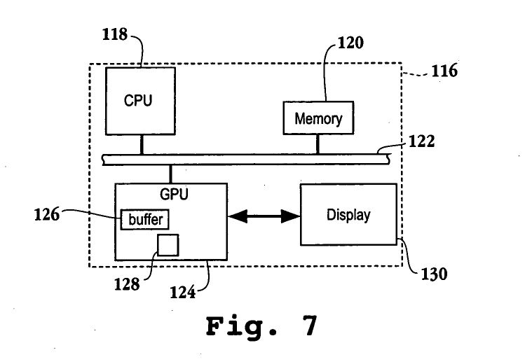

FIG. 6 is a schematic diagram of a mapped table and corresponding compressed data for use in illustrating the methodology to generate complex borders in a graphics controller in accordance with one embodiment of the invention. Here, a 44×40 heart shaped border depicted in mapped table 112 is used for exemplary purposes in order to illustrate the methodology. It should be appreciated that region 112 represents a mapped table where each value of the mapped table is a single bit value. Compressed data 115 represents mapped table 112 using the compressed data structure discussed above with reference to FIG. 5. Thus, the first two bytes, 81 and 8e represent the first 142“1's” in mapped table 112. The first 142 “1 s” are represented in region 114 as counted from left to right for each successive row. It should be appreciated that since the seven bits of the data structure represented in FIG. 5 may only represent a maximum value of 128, two consecutive bytes having a common MSB are combined in order to represent numbers larger than 128 as discussed above.

For exemplary purposes, the correlation between compressed data 115 and mapped table 112 is presented. Referring to region 114 of FIG. 6, there are 142 consecutive “1's” prior to encountering a “0.” In the binary system, the decimal number 142 is represented as 10001110. As this is an eight bit number, two bytes of data will be needed to capture the number. Each byte of data will include a MSB that indicates the pattern is the border pattern, which for this example is indicated by a logical high value (1). Thus, the hexadecimal numbers 81 and 8e represent the two bytes of data which are later concatenated to yield the 142 consecutive “1's.” As described above, the concatenation process removes the MSB from each binary byte of data and combines the remaining bits. In this particular example, 81 in hexadecimal is equivalent to 10000001 in binary, while 8e is equivalent to 10001110 in binary. Thus, as the MSB for each binary byte are the same, thereby signaling that the two bytes are to be combined. Here, the binary equivalent of 81 minus the MSB (which is equal to 0000001) is combined with the binary equivalent of 8e minus the MSB (which is equal to 0001110). The resulting 14 bit combination is 00000010001110, which corresponds to 142. It should be noted that a two-byte number captures what was previously 142 bits in the mapped table to realize a significant memory savings.

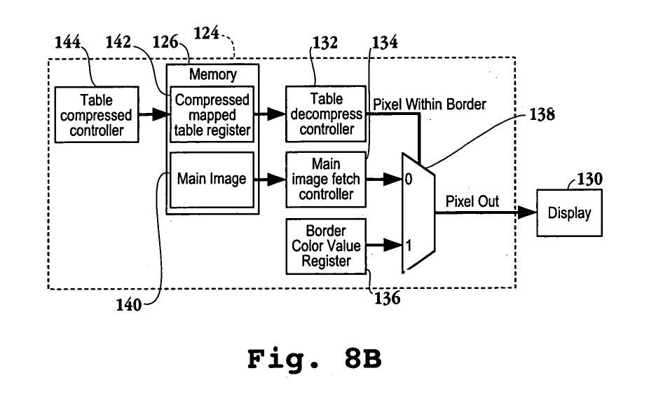

Continuing with the compressed data, the next string is represented by 04 (00000100). Here, the MSB is a “0” indicating that the main image data is used. It should be appreciated that if the MSB was a “1,” then this value would be concatenated with the 81 and 8e values as discussed above. Removing the MSB of “0” yields a string of four “0's.” This technique is repeated for the remaining compressed data in a similar fashion. The mapped table is converted to the compressed data, stored, and then decompressed though the table decompress controller module with reference to FIGS. 8A and 8B. In one embodiment, a user is able to define their own compressed table by inputting data through table compressed controller 144 of FIG. 8B.

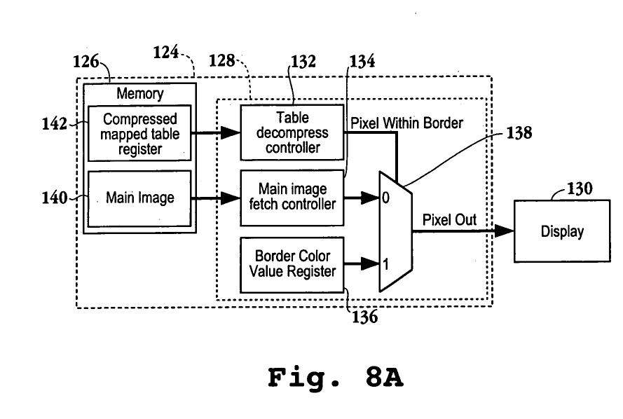

FIG. 7 is a high level schematic diagram illustrating a device configured to provide borders in an efficient manner in accordance with one embodiment of the invention. Device 116 includes central processing unit (CPU) 118, memory 120, graphics processing unit (GPU) 124, and display 130. Each of CPU 118, memory 120, and GPU 124 are in communication through bus 122. GPU 124, which may also be referred to as a display controller, is in communication with display 130. In one embodiment, display 130 is a liquid crystal display (LCD). It should be appreciated that device 116 may be any consumer electronic device, such as a cellular phone, personal digital assistant (PDA), web tablet, pocket personal computer, etc. GPU 124 includes memory region 126 and border generation logic 128. Border generation logic 128 includes logic configured to generate a border around a main image as described herein. For example, border generation logic 128 will include logic configured to achieve the functionality for defining the compressed data structure from a mapped table as described in further detail below. It will be apparent to one skilled in the art that the logic modules described herein include, software, hardware, or some combination of the two.

FIG. 8A is a schematic diagram further defining the border generation logic of FIG. 7. Graphics processor unit includes border generation logic 128. Border generation logic 128 includes table decompressed controller module 132, main image fetch controller 134 and border color value register 136. Main image fetch controller 134 and border color value register 136 output data to multiplexer 138. A select signal generated through cable decompressed controller module 132 selects a pixel value associated with either the main image or the border color for output to display 130. Memory 126 includes compressed mapped table register 142 and main image region 140. Compressed mapped table register 142 includes data in the compressed data structure described with reference to FIG. 5. That is, the mapped table of FIGS. 3 and 6 may be stored in compressed format in compressed mapped table register 142. Main image region 140 includes the digital data associated with the main image, e.g., the castle of FIG. 2. Table decompress controller module 132 is capable of accessing memory 126, in particular compressed mapped table register 142. Table decompress controller module 132 then decompresses the compressed data structure in order to determine if the pixel value is within a border or outside of the border. Based upon that value, a logical high or a logical low value is transmitted to multiplexer 138 in order to select between a main image pixel and a border color pixel for presentation on a display screen. In one embodiment, table decompressed controller module 132 is a 14 bit counter.

FIG. 8B is an alternative embodiment to the border generation logic illustrated in FIG. 8A. Here, table compressed controller module 144 is included to thereby enable a user to define a customized border. Rather than downloading a border from a list of available borders, table compressed controller module 144 enables a user to define a custom border. Thus, a user can enter data in the form of logical high and logical low values to define a mapped table which may or may not be further compressed as described above. The mapped table or compressed data associated with the mapped table is stored and then used to combine the main image with a border as discussed with reference to FIG. 8A. It should be appreciated that in one embodiment, the border generation logic illustrated in FIG. 8B may be applied to higher end consumer electronic devices in which enhanced functionality is made available to a user to enable border customization. It should be further appreciated that border color value register 136 may output a single border color or may be configured to generate multiple colors which change either randomly or according to some pattern. Thus, the border may include one or many colors.

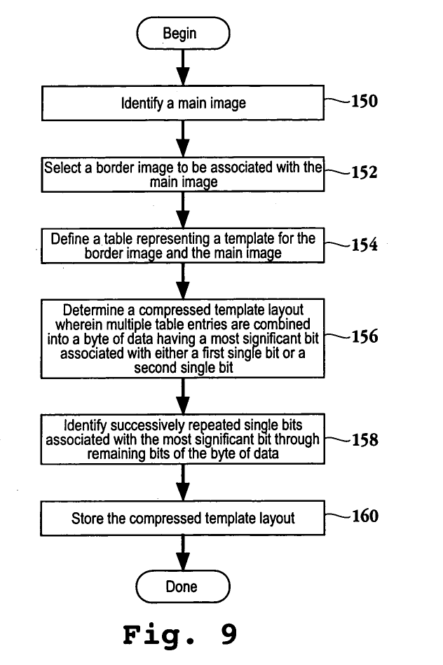

FIG. 9 is a flowchart diagram illustrating the method operations incorporating a border with a main image in accordance with one embodiment of the invention. The method initiates with operation 150 where a main image is identified. Here, the main image may be the castle described with reference to FIG. 2. The method then advances to operation 152 where a border image to be associated with the main image is selected. As an exemplary illustration, the border image may be a heart shaped border as illustrated in FIG. 1. The border may be a custom border or selected from a predefined list. In addition, the border may be downloaded from a server through a wireless or wired connection. The method then proceeds to operation 154 where a table representing a template for the border image in the main image is defined. In one embodiment, the table is the mapped table illustrated with reference to FIGS. 3 and 6. As described above, the table includes single bit values corresponding to either image or border data. The method then moves to operation 156 where a compressed template layout is determined. Here, the multiple table entries of the mapped table are combined into a byte of data having a MSB associated with either a first single bit or second single bit. The first single bit and the second single bit represent a pattern or source of the data, e.g., a border image color or a main image color.

The method of FIG. 9 then proceeds to operation 158 where successively repeated single bits associated with the MSB are identified through the remaining bits of the byte of data. It should be appreciated that if the number of successively repeated single bits is greater than a maximum number that may be represented through a seven-bit number, two bytes of data will be combined in order to represent the string of successively repeated single bits as described above. Thus, the MSB defines a pattern, i.e., a border image or a main image, while the remaining seven bits of the byte of data determines how many times that pattern is replicated. The method then proceeds to operation 160 where the compressed template layout is stored. The stored data is decompressed and a select signal is utilized as described with reference to FIGS. 8A and 8B in order to generate a border for a main image.

In summary, the above-described embodiments enable the generation of complex borders while minimizing the memory footprint and power required to generate the complex borders. A border image is mapped to a table through single bit values, wherein the single bit values may be associated with one of two values. The two values include a value associated with the border image and a value associated with the main image. In one embodiment, a user may customize a border rather than selecting predefined borders. Here, the user enters the raw data for the mapped table. The mapped table may be stored or further compressed through application of the data structure to the single bit values of the mapped table. When applying the embodiments described herein to a 132×176 panel, a heart-shaped border uses about 280 bytes, a star-shaped border uses about 320 bytes, an ellipse-shaped border uses about 210 bytes. Compared to the 2904 bytes raw data, (the mapped table having single bit values) the compressed mode can significantly reduce memory requirements, not to mention the savings compared to data having a color depth of 8 bpp or more.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A method for incorporating a border around a displayed image, comprising the operations of:
identifying a main image;
selecting a border image to be associated with the main image;
mapping the border image to a table such that each pixel of the border image is represented by a corresponding single bit in the table, the mapping including,
defining a first single bit value for respective border image pixels; and
defining a second single bit value for respective main image pixels;
applying the table to a display of the main image in order to incorporate the border image with the main image.

2. The method of claim 1, wherein the method operation of mapping the border image to a table such that each pixel of the border image is represented by a corresponding single bit in the table includes,
compressing data defining the table, the compressing including,
identifying a compressed value to represent whether the corresponding single bit is one of the first single bit value and the second single bit value and how many identical single bits follow the corresponding single bit in the table.

3. The method of claim 2, further comprising:
defining the compressed value as a byte, wherein a most significant bit of the byte is associated with the one of the first bit value and the second bit value, the remaining bits of the byte corresponding to successively repeated bits of the one of the first bit value and the second bit value.

4. The method of claim 2, further comprising:
determining if an amount of identical single bits following the corresponding single bit in the table is greater than a maximum amount capable of being represented by a seven bit value;
if the amount of identical single bits is greater than the maximum amount, then the method includes,
combining multiple bytes to represent the compressed value, wherein each of the multiple bytes have a common most significant bit.

5. The method of claim 4, further comprising:
representing the amount of identical single bits as a combination of the multiple bytes in which the common most significant bit is removed.

6. The method of claim 1, wherein the method operation of mapping the border image to a table such that each pixel of the border image is represented by a corresponding single bit in the table includes,
defining a compressed data structure to represent a block of successively repeated single bits in the table;
storing the compressed data structure; and
generating the table through decompression of the compressed data structure.

7. The method of claim 6, wherein the compressed data structure is a byte of data having a most significant bit representative of one of the first single bit value and the second single bit value and remaining bits of the byte of data indicating an amount associated with the successively repeated bits.

8. A method for customizing a border around a displayed image, comprising the operations of:
identifying a main image;
selecting a border image to be associated with the main image;
defining a table representing a template for the border image and the main image such that each pixel of the border image is represented by a corresponding first single bit in the table and the main image is represented by a corresponding second single bit in the table.

9. The method of claim 8, further comprising:
applying the table to a display of the main image in order to incorporate the border image with the main image.

10. The method of claim 8, wherein the method operation of selecting a border image to be associated with the main image includes,
determining a compressed template layout wherein multiple table entries are combined into a byte of data having a most significant bit associated with one of the first single bit and the second single bit.

11. The method of claim 10, further comprising:
identifying successively repeated single bits associated with the most significant bit through remaining bits of the byte of data.

12. The method of claim 10, further comprising:
storing the compressed template layout;
requesting the main image be combined with the border image; and
decompressing the compressed template layout in response to the request

13. The method of claim 9, wherein the method operation of applying the table to a display of the main image in order to incorporate the border image with the main image includes,
selecting one of a main image pixel value and a border image pixel value based on a value of the template.

14. A graphics processing unit (GPU), comprising:
border generation logic configured to apply a border to an image, the border generation logic including,
logic for generating a table mapping border data with image data such that both the border data and the image data are represented by corresponding single bit values in the table;
logic for compressing the border data and the image data such that multiple successive single bit values in the table are compressed to a value representing whether one of the corresponding single bit values is one of a first single bit value and a second single bit value and a number of identical single bit values following the one of the corresponding single bits in the table; and
logic for storing the compressed data in a buffer associated with the GPU.

15. The GPU of claim 14, further comprising:
logic for accessing the compressed data in the buffer; and
logic for decompressing the compressed data in order to present the image having the border.

16. The GPU of claim 15, wherein the logic for decompressing the compressed data in order to present the image having the border includes,
logic for identifying a most significant bit of the decompressed data as being associated with one of the first single bit value and the second single bit value; and
logic for determining a number of repeated bits following the most significant bit.

17. The GPU of claim 15, wherein the logic for decompressing the compressed data is a 14 bit counter.

18. The GPU of claim 16, wherein the logic for determining a number of repeated bits is configured to provide a select signal to a multiplexer based upon the most significant bit.

19. The GPU of claim 14, wherein the value is an eight bit value, the eight bit value having a most significant bit corresponding to one of the first single bit value and the second single bit value, the first single bit value associated with the border, the second single bit value associated with the image.

20. The GPU of claim 19, further comprising:
logic configured to identify when the number of identical single bit values following the one of the corresponding single bit values in the table is greater than can be represented by a seven bit binary value; and
logic configured to generate another eight bit value having the most significant bit, wherein remaining seven bits of the another eight bit value are associated with the seven bit binary value to define a fourteen bit binary value capable of capturing the number of identical single bit values.

21. A device, comprising:
a graphics processing unit (GPU) configured to provide image data having a border to a display panel for presentation, the GPU including,
logic for generating a table mapping border data with the image data, the table being defined by single bit values; and
logic for compressing the single bit values of the table such that repeated successive single bits in the table are compressed to an eight bit value having a most significant bit determining whether the repeated successive single bits are associated with one of the border data and the image data, wherein remaining seven bits of the eight bit value represent a quantity of the repeated single bits.

22. The device of claim 21, further comprising:
a central processing unit (CPU);
a main memory;
a display panel in communication with the GPU; and
a bus in communication with the CPU, memory, and the GPU.

23. The device of claim 21, wherein the GPU includes a memory region having a display buffer, the display buffer configured to store the compressed single bit values.

24. The device of claim 21, wherein the device is selected from the group consisting of a cellular phone, a pocket personal computer, a web tablet, and a personal digital assistant (PDA).

25. The device of claim 21, wherein the logic for generating a table includes,
logic for receiving the table from a distributed network in which the device is in communication with.

26. The device of claim 25, wherein the device is in communication with the distributed network over one of a wired connection and a wireless connection.
